(19) United States
(12) Patent Application Publication
(10) Pub. No.: US 2008/0041227 A1
(43) Pub. Date: Feb. 21, 2008

(54) Process for Removal of Mercury from Gas Stream

(76) Inventors: Robert C. Mulvaney III, Spanish Fort, AL (US); Keith R. Clark, Houston, TX (US); Vladislav I. Kanazirev, Arlington Heights, IL (US); Henry Rastelli, Gurnee, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/464,553

(22) Filed: Aug. 15, 2006

(51) Int. Cl. B01D 53/02

(52) U.S. Cl. 95/135

(57) ABSTRACT

The present invention comprises a process for removal of mercury from a gas stream. It has been found that a metal oxide, preferably copper oxide adsorbent on an alumina substrate can be sulfided in situ while in service to remove mercury. In particular, a copper oxide adsorbent is used that adsorbs sulfur at the same time as it adsorbs mercury. It is actually the sulfur that actually chemisorbs the mercury. The rate of uptake of sulfur is dependent on the amount of sulfur in the feed to the bed. The sulfur content of the gas is typically 2 orders of magnitude that of the mercury, which provides more than enough sulfur to react and remove the mercury.

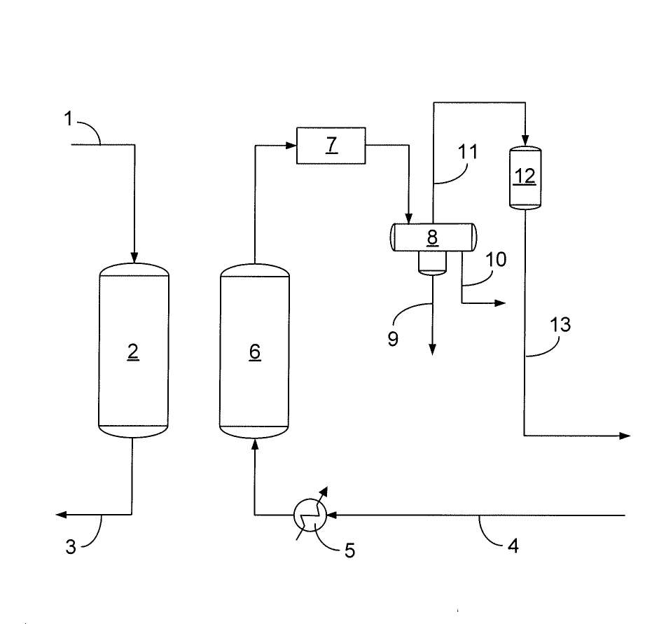

### FIELD OF THE INVENTION

This invention relates to a process for removal of mercury from a gas stream. More particularly, this invention relates to the use of a first adsorbent bed to remove mercury from a gas stream, regeneration of this first adsorbent bed, followed by the use of a second adsorbent bed in which the adsorbent is sulfided in situ to remove mercury from the regeneration gas stream

### BACKGROUND OF THE INVENTION

It is known that, depending on its origin, natural gas contains variable quantities of mercury, generally 0.1 to 50 μg/m³ of gas. This leads to the danger of pollution by toxic mercury as well as danger of corrosion to certain materials in which the natural gas has to travel. It is therefore essential to provide a process for the removal of mercury from natural gas. In addition to natural gas, other fluids contain traces of mercury and require treatment such as electrolytic hydrogen.

It is known that certain metals, for example gold, silver and copper form amalgams with mercury and that this property is used particularly in mercury dosing. Mercury extraction by these metals has not been used industrially on a large scale because the volume of charge per volume of trapping mass and per hour which can be used is very small with known devices where the metal used for extraction is in mass form, particularly wires, plates, crushed material etc. Such a mass form does not provide sufficient metal area per gram of metal to permit industrial utilization for the treatment of large quantities of gas or liquid, since the weight and cost of the extracting metal required becomes prohibitive. The literature is replete with various nonregenerable mercury trap examples. They include sulfur deposited on activated carbon, sulfur on alumina, metal sulfides on carbon, and metal sulfides on alumina. They are typically proposed for treatment of the main gas stream. They become saturated and are eventually replaced.

One solution on the market has been a regenerable material (silver impregnated molecular sieve) which is not only a mercury adsorbent, but has capacity for water and other impurities, as well. The advantage to the use of these silver impregnated adsorbents is that there is no extra vessel required for mercury removal. The mercury is regenerated off of the adsorbent along with the water and other impurities in the feed. Silver containing adsorbents are disclosed in several patents assigned to UOP LLC, including U.S. Pat. No. 5,523,067.

Sulfur supported on alumina, silica and other refractory oxides has been considered for use as a mercury guard bed. U.S. Pat. No. 4,814,152 assigned to Mobil and U.S. Pat. No. 4,474,896 disclose using a sulfur containing adsorbent. The '896 patent discloses the use of a number of support materials to contain a polysulfide for adsorption of mercury. The support materials listed include metal oxides. U.S. Pat. No. 4,094,777 discloses the use of a copper sulfide on alumina to remove mercury. A support is treated with a copper compound followed by sulfurization.

Most recently, ICI in U.S. Pat. No. 6,007,706 and U.S. Pat. No. 6,221,241 disclosed the use of a copper based adsorbent to remove a sulfur contaminant followed by removal of a second contaminant such as mercury, phosphine, stibine and/or arsenic with the resulting copper based sulphided bed. This system is designed to be nonregenerable, with replacement of the adsorbent as it becomes saturated with impurities.

U.S. Pat. No. 5,281,258 to Markovs discloses a process for removing mercury vapor from a natural gas stream which comprises mercury and water. The natural gas stream is passed through a first fixed bed adsorber containing a regenerable adsorbent which adsorbs mercury and water and a purified effluent is recovered. The flow of the natural gas stream to the first adsorber bed is terminated and a heated purge desorbent stream is passed through the first adsorbent bed to desorb mercury and water to produce a spent regenerant. The spent regenerant is cooled and condensed to recover liquid mercury and water. The remainder of the spent regenerant is passed to a second fixed bed adsorber containing a regenerable adsorbent with a strong affinity for adsorbing water to produce a second effluent, decreased in water. The second effluent is cooled and condensed to condense out a portion of the mercury from the second effluent. The second fixed bed adsorber is regenerated with a portion of the heated purge desorbent and is not recovered. The second fixed bed adsorber is required to remove water prior to the condensing out of the mercury to prevent hydrate formation.

U.S. Pat. No. 5,281,259 to Markovs discloses a process for the removal of mercury from a natural gas stream wherein the mercury vapor contained in the purge gas used to regenerate the adsorption beds is recovered as liquid mercury. In this scheme, a primary spent purge desorbent from a primary bed undergoing desorption is cooled and condensed to recover mercury and water and the remaining material is passed to a secondary bed containing a regenerable adsorbent for mercury to produce a second effluent stream depleted in mercury. Another secondary bed undergoing regeneration at the same time as the primary bed is purged with a portion of the purge desorbent to produce a secondary spent regenerant. The secondary spent regenerant is combined with the primary spent desorbent prior to the cooling and condensing step.

U.S. Pat. No. 5,271,760 to Markovs discloses a process for the removal of mercury from a process feedstream to recover liquid mercury. The process comprises the passing of the feedstream periodically in sequence through two fixed beds containing a regenerable adsorbent selective for the adsorption of mercury. Each of the beds cyclically undergoes an adsorption step wherein the feedstream is passed through the bed to selectively adsorb mercury and to produce an effluent stream, and a purge desorption step wherein the adsorbed mercury is desorbed by passing a regeneration fluid through the bed to produce a second effluent. The improvement comprises the tandem operation of the beds so that as one bed is operating in the adsorption step, the other bed is operating in the purge desorption step and the second effluent is cooled and condensed to recover a portion of the mercury. Markovs further discloses that the remainder of the second effluent is recombined with the feedstream and passed to the bed undergoing adsorption. The above U.S. Pat. No. 5,281,258; U.S. Pat. No. 5,281,259 and U.S. Pat. No. 5,271,760 are hereby incorporated by reference.

Perhaps the two greatest problems involved in removing mercury from process streams are (a) achieving a sufficient reduction in the mercury concentration of the feedstream being treated and (b) avoiding the reentry of the recovered mercury into some other environment medium. Although permissible levels of mercury impurity vary considerably, depending upon the ultimate intended use of the purified product, for purified natural gas, a mercury concentration greater than about 0.01 microgram per normal cubic meter (μg/Nm³) is considered undesirable, particularly in those instances in which the natural gas is to be liquefied by cryogenic processing. To attain lower concentration levels requires the use of relatively large adsorption beds and relatively low mercury loading. If non-regenerable, the capital and adsorbent costs are uneconomical, and if regenerable, the regeneration media requirements are not only large, but also result in a large mercury-laden bed effluent which must itself be disposed of in an environmentally safe manner. Furthermore, the high volume of regeneration gas required to be first heated and then cooled to recover the mercury can result in oversized regeneration equipment which increases the capital and utility costs of the process installation.

Purification processes are sought for the efficient removal and recovery of mercury from hydrocarbon streams with a minimum of process equipment. UOP's offering has been a regenerable material (silver impregnated molecular sieve) which is not only a mercury adsorbent, but has capacity for water and other impurities, as well. The advantage is that there is no extra vessel required for mercury removal. The mercury is regenerated off the adsorbent along with the water and other impurities in the feed.

There are cases where a customer wants to remove the mercury from the regeneration gas. This is more problematic than treating a large gas stream, because the regeneration gas will be near its dew point. The presence of liquid hydrocarbons causes problems for sulfur based materials in that the sulfur is soluble in hydrocarbon. Condensation in the pores of carbon carrier also blocks access to the sulfur. Accordingly, it would be useful to employ a process in which an adsorbent does not contain elemental sulfur when placed into service. Such an adsorbent has now been developed. It further would be useful to use the existing silver containing adsorbent systems for initial removal of mercury from product streams.

### SUMMARY OF THE INVENTION

The present invention comprises a process for removal of mercury from a gas stream. It has now been found that the combination of a large bed having a first section for removal of water and a second section for removal of mercury with a separate adsorbent bed for removal of mercury from the regeneration gas stream of the first bed is very effective in operation. A metal oxide adsorbent is effective in such a separate adsorbent bed for removal of mercury. In particular, it has been found that a copper oxide adsorbent on an alumina substrate can be sulfided in situ while in service to remove mercury. In a preferred embodiment, a copper oxide adsorbent is used that adsorbs sulfur at the same time as it adsorbs mercury. It is actually the sulfur that actually chemisorbs the mercury. The rate of uptake of sulfur is dependent on the amount of sulfur in the feed to the bed. The sulfur content of the gas is typically 3 orders of magnitude that of the mercury, which provides more than enough sulfur to react and remove the mercury. The chemistry is described below:

CuO+H₂S→CuS+H₂O

CuS+Hg→Cu+HgS

The regenerable mercury adsorbent in the treater bed (first adsorbent bed) is usually at the bottom, and regeneration is counterflow. The result is that for a given regeneration cycle, the sulfur, which adsorbs at the feed inlet of the first adsorbent bed, exits the treater first, sulfiding the non-regenerative copper oxide adsorbent in the second bed, and the mercury follows.

In a proposed flow scheme, the sulfur and mercury containing regeneration gas enters the copper oxide/alumina bed very near the dew point. Should hydrocarbon condensation be possible, there are two phenomena which will inhibit the performance of other mercury adsorbents like elemental sulfur or carbon materials. First, the elemental sulfur is soluble in hydrocarbon, and will be removed from the bed. Second, the propensity of activated carbon to condense hydrocarbon in the pore structure will prevent mercury from contacting the sulfur and reacting. The CuO/Alumina provides high availability of the insoluble CuO or CuS.

A particularly effective adsorbent for use in the present invention has a high BET surface area. We found that high BET surface transition alumina can produce a highly efficient scavenger for H₂S, COS and other S compounds when subjected to a reactive agglomeration with a solid oxysalt, e.g. basic carbonate of a transition metal such as copper, and an alkali metal compound upon addition of water. The agglomeration is followed by a curing process and thermal treatment which does not decompose the oxysalt but leave behind at least one additional mol H₂O per each mol oxysalt available. The resultant product has a higher sulfur loading as compared to COS scavengers produced by the known methods. Also this product exhibits fast COS reaction rates even at ambient temperature. This provides a simple and economical method of production and application. The adsorbent produced according to the present invention does not promote appreciably any catalytic reactions even with reactive main streams.

In one embodiment, the invention involves a process for removing mercury vapor from a natural gas stream comprising the steps of providing a natural gas stream containing at least 0.02 μg/nm³ of elemental mercury, at least 1 ppm sulfur compounds and at least 25 ppm (v) water. The natural gas stream is passed at a temperature within the range of 0° to 65° C. and at a pressure within the range of 25 to 2500 psia into a first fixed adsorption bed containing an adsorbent mass upon which the mercury and water are preferentially adsorbed whereby a mercury mass transfer front and a water mass transfer front are formed, mercury and water are adsorbed and a mercury-depleted and water-depleted stream is recovered as the effluent therefrom. Then the flow of the natural gas stream is terminated into the first fixed adsorption bed prior to breakthrough of the mercury mass transfer front and the first fixed bed is regenerated by passing thereinto, at a temperature higher than the temperature of the stream when passing into the first adsorbent bed and at a pressure of at least 25 psia, a purge desorbent whereby mercury and water are desorbed from the bed into the effluent, and wherein the effluent further comprises at least 1 ppm sulfur compounds. This effluent is cooled to condense out a portion of the mercury and water content thereof and the remainder of the fluid stream is sent to a second fixed bed containing an adsorbent comprising a metal oxide conodulized with a support wherein after contact with the sulfur compounds within said effluent, this adsorbent within the second fixed bed has a strong affinity for mercury so that the mercury within the effluent is adsorbed onto the adsorbent in the second fixed bed.

### BRIEF DESCRIPTION OF THE DRAWING

The FIGURE represents a schematic block flow diagram of the process of the present invention.

### DETAILED DESCRIPTION OF THE INVENTION

The gas feed stream is first treated in a first adsorbent bed having a first section to remove water from the gas feed stream, such as a Na A zeolite. In the second section of the first adsorbent bed, preferred adsorbents are those which comprise constituents chemically reactive with mercury or mercury compounds. Various cationic forms of several zeolite species, including both naturally occurring and synthesized compositions, have been reported by Barrer et al. [J. CHEM. Soc. (1967) pp. 19-25] to exhibit appreciable capacities for mercury adsorption due to the chemisorption of metallic mercury at the cation sites. Some of these zeolitic adsorbents reversibly adsorb mercury and others exhibit less than full, but nevertheless significant, reversibility. An especially effective adsorbent for use in the present process is one of the zeolite-based compositions containing cationic or finely dispersed elemental forms of silver, gold, platinum or palladium. A particularly preferred adsorbent of this type is disclosed in U.S. Pat. No. 4,874,525 (Markovs) in which the silver is concentrated on the outermost portions of the zeolite crystallites. This adsorbent, as well as the other zeolite-based adsorbents containing ionic or elemental gold, platinum, or palladium, is capable of selectively adsorbing and sequestering organic mercury compounds as well as elemental mercury. Zeolite A containing elemental gold is disclosed as an adsorbent for mercury in U.S. Pat. No. 4,892,567 (Yan). The specific mention of these materials is not intended to be limiting, the composition actually selected being a matter deemed most advantageous by the practitioner give the particular circumstances to which the process in applied.

The temperature and pressure conditions for the filtration and the adsorption purification steps are not critical and depend to some degree upon the particular feedstock being purified and whether the adsorption step is to be carried out in the liquid or in the vapor phase. Temperatures typically range from about 16° to 60° C. in the beds during the adsorption-purification step. If the adsorption bed is to be regenerated the purge medium is heated to at least 100° C., and preferably at least 200° C., higher than the temperature of the feedstock being purified. Pressure conditions can range from about 140 kPa to about 17.5 Mpa (20 to 2500 psia) and are generally not critical, except during liquid phase operation where it is necessary to maintain sufficient pressure at the operating temperature to avoid vaporization of the feedstock.

In the present invention, it has been found that the in situ sulfidation of a copper oxide containing adsorbent provides very favorable results. The copper oxide adsorbent is an agglomeration which is preferably produced by using a transition-phase alumina; an oxysalt of a transition metal; an alkali metal compound (AM) and active water (AW).

The transition alumina usually consists of a mixture of poorly crystalline alumina phases such as “rho”, “chi” and “pseudo gamma” which are capable of quick rehydration and can retain substantial amounts of water in a reactive form. An aluminum hydroxide (Al(OH)₃), such as Gibbsite, is the typical source for preparation of transition-phase alumina. The typical industrial process for production of transition-phase alumina includes milling Gibbsite to a particle size between 1-20 microns followed by flash calcination for a low contact time as described in U.S. Pat. No. 2,915,365. Amorphous aluminum hydroxide and other crystalline hydroxides, e.g. Bayerite and Nordstrandite or monoxides-hydroxides AlOOH such as Boehmite and Diaspore can also be used as a source of transition-phase alumina. In this invention we are using transition-phase alumina produced in the UOP plant in Baton Rouge, La. The BET surface area of this material is about 300 m²/g and the average pore diameter is about 30 Angstroms as determined by nitrogen adsorption.

A solid oxysalt of a transitional metal is used as a component of the composite. Oxysalt, by definition, refers to any salt of an oxyacid. Sometimes this definition is broadened to “a salt containing oxygen as well as a given anion”. FeOCl, for example, is regarded as an oxysalt according this definition. For the purpose of this work, we use basic copper carbonate (referred to as “BCC”) with a formula of Cu(OH)₂CuCO₃. This is a synthetic form of the mineral malachite, produced by Phibro-Tech, Ridgefield Park, N.J. The particle size of the BCC particles is approximately in the range of that of the transition alumina—1-20 microns. Another useful oxysalt would be Azurite with a formula of Cu₃(CO₃)₂(OH)₂. Generally, oxysalts of Cu, Ni, Fe, Mn, Co, Zn or mixture of elements can be successfully used

An alkali metal compound is another component of the composite or agglomerate. This compound can be a part of the transition alumina or added separately in the process of agglomerate preparation. Typically transition alumina contains about 0.3 mass-% sodium calculated as the oxide. Addition of NaOH in the agglomeration process is used in order to boost the Na₂O content of the final composite to 0.6-0.7 mass-%. Thus, the pH of the liquid added in the course of the agglomeration process is between 13.1-13.7.

Finally, water is also a component used in making the reactive composite. The process of preparation of the reactive composites is a series of chemical reactions in which water plays a very important role. Typically, the amount of water added during the agglomeration process is about 50% of all other ingredients. In the course of the curing process, which can be performed at ambient temperature for at least 12 hours or at a slightly elevated temperature from 60° to 70° C., water participates in different processes which result in an attachment of water molecules to the other composite ingredients.

Various sulfur species are removed, including hydrogen sulfide, ethyl sulfide, methyl mercaptan, ethyl mercaptan, and other sulfur compounds. Carbonyl sulfide is a common contaminant that needs to be removed. The thermal treatment, which follows the curing step, leaves enough water in the material in order to carry out COS removal until the complete exhaustion of the scavenging element, which is the transition metal in this case. The final composite should contain excess water, beyond the water from the carbonate's hydroxyl groups, in order to convert all the Cu available to CuS through a reaction with COS.

Thus, the first step is preparation of a “hydrated” active component as described in the following equation, where “a”, “b” and “c” refer to gram moles. The “c” in the equation is at least equal to “a” and not higher than 10 times “a”.

(Cu(OH)₂CuCO₃)ₐ.(Al₂O₃)_{b}+cH₂O=(Cu(OH)₂CuCO₃)ₐ(Al₂O₃)_{b}(H₂O)_{c}

The COS reacts then with the composite as shown below in this reaction:

(Cu(OH)₂CuCO₃)ₐ.(Al₂O₃)_{b}.(H₂O)_{c}+2aCOS=2aCuS+bAl₂O₃+3aCO₂+(c+a)H₂O

The alkali element (not shown for simplicity in the equations) provides for a higher rate of COS hydrolysis which is catalyzed by the alumina component. Since the alumina component plays not only the role of a COS hydrolysis catalyst, but is also the bearer of most of the reactive water, the ratio a/b is from 0.05 to about 1.2. The preferred ratio is in the 0.3-0.6 range. The alkali metal expressed as an oxide is usually not more than 5% of the mole fraction of the aluminum oxide—“b”. Finally the excess water is at least 15% of the mole fraction of the aluminum oxide—“b”

It should be noted that the ratios listed above are only an example for oxysalts similar to the basic copper carbonate. Other salts would require different ratios depending upon various factors including the content and valence of the transition element, the sulfur compound formed upon reaction with H₂S and the hydroxyl content of the initial oxysalt.

The azurite Cu₃(OH)₂(CO3), for example, would require 2 moles of additional water available in order for the reaction of the Cu compound with COS to go to completion.

It is believed that agglomeration in a rotating pan followed by reactive curing and custom activation, either as a part of adsorbent manufacture or just before its use is a preferred way to practice the invention. The following example illustrates the production method for the adsorbent.

### EXAMPLE

A four feet rotating pan device was used to continuously form beads by simultaneously adding transition alumina and basic copper carbonate (BCC) powders while spraying the powders with water. The pH of the water was adjusted to pH 13.5 by adding a NaOH solution. The transition alumina (TA) powder was produced by UOP LLC in Baton Rouge, La. The basic copper carbonate was obtained as “dense” powder from Phibro-Tech (Ridgefield Park, N.J.). The mass ratio of BCC: TA was 45:55, which corresponds to a mole ratio “a/b” of about 0.38. The water feeding rate was adjusted to provide for sufficient agglomeration and maximize the content of 8×14 mesh size fraction. The water feeding rate was approximately equal to the feeding rate of the BCC powder. The “green” agglomerates were collected after discharging from the rotating pan and subjected to “drum” curing at ambient temperature.

The product from the Example is then used to remove sulfur compounds, such as H₂S, from a hydrocarbon stream. In removing the sulfur compounds, a large amount of CuS is formed in the adsorbent bed. We have found that accommodating large amount of the active component—CuS while maintaining high total surface area has a positive effect on the Hg removal capability of the final material.

A McBain-Baker adsorption apparatus was used to determine the H₂S loading on different adsorbents. The following table shows the loading data at 5 torr H₂S and 22° C. on an adsorbent made in accordance with the Example together with analytical data for S content as determined on the spent samples by the combustion method.

| | CuO | | McBain | | S loading by |
|---|---|---|---|---|---|
| | content | BET | loading | S analysis | analysis |
| Sample # | Mass-% | m²/g | g/100 g fresh | Mass-% | g/100 g fresh |
| 1 | 31.7 | 278 | 12.89 | 10.60 | 11.86 |
| 2 | 32.8 | 242 | 13.06 | 11.80 | 13.38 |
| 3 | 33.5 | 249 | 13.02 | 11.80 | 13.38 |
| 4 | 33.6 | 247 | 13.11 | 10.80 | 12.11 |
| 5 | 34.5 | 244 | 13.27 | 11.20 | 12.61 |
| 6 | 34.4 | 247 | 13.60 | 11.20 | 12.61 |
| 7 | 33.3 | 249 | 13.24 | 11.10 | 12.49 |

One can see from the data that there is a good correlation between the values obtained by the mass gain as measured in the McBain apparatus and the S loading. All samples achieve close to the theoretical limits of S pick-up determined by the following sulfidation reaction:

CuO+H₂S=CuS+H₂O

The data in the above table suggest that the samples can be easily sulfided at ambient conditions even at low partial pressure of H₂S and static atmosphere. X-ray analysis of a spent sample confirmed that the CuS is the only copper containing crystalline phase present in the sample.

In conclusion, we have found through pilot plant testing conditions at which the adsorbent of the Example could be sulfided under the least favored conditions such as large excess of hydrogen in the gas mix.

A comparison between the present invention in column 1 and a current commercial product in column 2.

Sample #

| | 1 | 2 |
|---|---|---|
| S content, mass-% | 11.5 | 5.4 |
| BET m2/g | 225 | 115 |

The material of the present invention contained more than twice the amount of sulfur, which may be attributed to a difference in the support material. The material of the Example is based on a transitional alumina support; while the commercial material contains gamma—theta type alumina as a support material. This explains the relatively low BET surface area of the commercial material.

The present invention provides a reactive copper component that converts easily to CuS upon sulfidation at mild conditions. Thus, a powerful mercury guard can be obtained by an in situ exposure of the adsorbent to sulfur contained in a hydrocarbon gas stream simultaneous to its use to remove mercury. The present invention removes at least 90% of the mercury present in a hydrocarbon gas stream, preferably at least 95% of the mercury and most preferably at least 99% of the mercury. Typically the hydrocarbon gas stream comprises at least 2.0 μg/nm³ of elemental mercury.

### DETAILED DESCRIPTION OF THE DRAWING

The FIGURE shows a simplified flow scheme. A gas feed stream, such as natural gas comes is shown as feed 1 that travels through adsorbent bed 2 containing an adsorbent for removal of at least water and mercury from the natural gas. A product stream that has been dried and purified of the mercury then leaves the adsorbent bed as purified feed 3. Normally in operation, there would be at least two adsorbent beds so that when a bed becomes saturated with impurities, it can be taken off line and regenerated leaving at least one adsorbent bed to continue removing impurities from the gas stream. In the FIGURE is shown an adsorbent bed 6 that is in regeneration mode, having a regeneration gas stream 4 that is first heated as shown by heat exchanger 5 before passing through adsorbent bed 6 to remove the water and mercury by using the heated regeneration gas. In some instances, the regeneration gas consists of a portion of product gas 3. Then the regeneration gas is sent through cooler 7 and then condenser 8 for removal of condensed water 10 and mercury 9. The cooled regeneration gas still contains an unacceptably high level of mercury and is sent to an adsorbent bed that contains a metal oxide adsorbent on an alumina support, preferably a copper oxide adsorbent on the alumina support. The regeneration gas further contains some sulfur compounds that react with the metal oxide to provide an effective adsorbent for removal of mercury. Spent regeneration gas 13 is then shown leaving adsorbent bed 12.

What is claimed is:

1. A process for removing mercury vapor from a natural gas stream which comprises the steps of:
a) providing a natural gas stream containing at least 0.02 μg/nm³ of elemental mercury, at least 1 ppm sulfur compounds and at least 25 ppm (v) water;
b) passing said stream at a temperature within the range of 0° to 65° C. and at a pressure within the range of 25 to 2500 psia into a first fixed adsorption bed containing an adsorbent mass upon which said mercury and water are preferentially adsorbed whereby a mercury mass transfer front and a water mass transfer front are formed, mercury and water are adsorbed and a mercury-depleted and water-depleted stream is recovered as the effluent therefrom;
c) terminating the flow of said natural gas stream into said first fixed adsorption bed prior to breakthrough of the mercury mass transfer front;
d) regenerating said first fixed bed by passing thereinto, at a temperature higher than the temperature of the stream in step (b) and at a pressure of at least 25 psia, a purge desorbent whereby mercury and water are desorbed from said bed into the effluent, wherein said effluent further comprises at least 1 ppm sulfur compounds;
e) cooling said effluent in step (d) to condense out a portion of the mercury and water content thereof; and
f) passing the remainder of the fluid stream to a second fixed bed containing an adsorbent comprising a metal oxide conodulized with a support wherein after contact with said sulfur compounds within said effluent, said adsorbent within said second fixed bed has a strong affinity for mercury and wherein mercury within said effluent is adsorbed onto said adsorbent in said second fixed bed.

2. The process of claim 1 wherein said metal oxide is a copper oxide.

3. The process of claim 1 wherein said support is alumina.

4. The process of claim 1 wherein said adsorbent in said second bed is prepared from a combination of a transition-phase alumina, an oxysalt of a transition metal, an alkali metal compound and water.

5. The process of claim 4 wherein said oxysalt of a transition metal is an oxysalt of Cu, Ni, Fe, Mn, Co, Zn or a mixture thereof.

6. The process of claim 5 wherein said oxysalt of a transition metal is Cu(OH)₂CuCO₃ or Cu₃(CO₃)₂(OH)₂.

7. The process of claim 4 wherein said alkali metal compound is NaOH.

8. The process of claim 4 wherein said transition-phase alumina has a BET surface area of about 300 m²/g.

9. The process of claim 1 wherein more than 90% of the mercury is removed from said gas stream.

10. The process of claim 1 wherein more than 95% of the mercury is removed form said gas stream.

11. The process of claim 1 wherein said gas stream comprises a natural gas stream.

12. The process of claim 11 wherein said natural gas stream comprises at least 2.0 μg/nm³ of elemental mercury.

13. The process of claim 1 wherein said adsorbent mass within said first adsorbent bed contains silver, gold, platinum or palladium supported on a zeolite or alumina.
